(19) United States
(12) Patent Application Publication
(10) Pub. No.: US 2026/0169656 A1
(43) Pub. Date: Jun. 18, 2026

(54) STORAGE SYSTEM AND A METHOD FOR OPERATING THE STORAGE SYSTEM

(71) Applicant: SAMSUNG ELECTRONICS CO., LTD., Suwon-si (KR)

(72) Inventors: Keoseong PARK, Suwon-si (KR); Jinyoung CHOI, Suwon-si (KR); Shicheng LI, Suwon-si (KR)

(73) Assignee: SAMSUNG ELECTRONICS CO., LTD., Suwon-si (KR)

(21) Appl. No.: 19/382,686

(22) Filed: Nov. 7, 2025

(30) Foreign Application Priority Data
Dec. 16, 2024 (KR) 10-2024-0187564

(51) Int. Cl. G06F 3/06

(52) U.S. Cl. CPC G06F 3/0659; G06F 3/0611; G06F 3/0679

(57) ABSTRACT

A storage system according to one embodiment may include a host device that generates a start event including identification information of an application, information about a start time, and information about a critical time period based on a request of an application, determines a critical section based on the start event, determines a priority of the request based on the identification information of the application, generates a command based on the request, and sets and outputs a priority of the command based on the priority of the request and the identification information of the application, and a storage device that schedules the command in a waiting queue based on the priority of the command received from the host device.

### CROSS-REFERENCE TO RELATED APPLICATION

This application claims priority to and the benefit of Korean Patent Application No. 10-2024-0187564 filed with the Korean Intellectual Property Office on December 16, 2024, the entire contents of which are incorporated herein by reference.

### BACKGROUND

### (a) Field

The present disclosure relates to a storage system and a method of operating the storage system.

### (b) Description of the Related Art

When using a smartphone, user experience (UX) is one of the important factors to consider. Creating a positive UX can lead to satisfying user needs and success in the market, but a negative UX can have a negative impact on users.

ANR Application Not Responding is one of the causes of negative UX. ANRs can be caused by incorrect application implementation, but can also be caused by delays in read requests responding to user input for a specific application. Accordingly, a method is required to eliminate ANR by preventing delay in read requests.

### SUMMARY

One embodiment relates to a storage system and a method of operating the storage system, which can prevent occurrence of ANR and provide improved UX by detecting the start of a critical section and increasing the priority of a read request and a command corresponding thereto that must be completed in the critical section.

According to one embodiment of the present invention for solving these technical challenges, a storage system may include a host device configured to generate a start event including identification information of an application, information about a start time, and information about a critical time period based on a request of the application, determine a critical section based on the start event, determine a priority of the request based on the identification information of the application, generate a command based on the request, and set and output a priority of the command based on the priority of the request and the identification information of the application, and a storage device configured to schedule the command to a waiting queue based on the priority of the command received from the host device.

A method of operating a storage system including a host device and a storage device according to one embodiment may include a step of receiving user input for an application, a step of generating a start event including identification information of the application, information about a start time, and information about a critical time period based on a request of the application, a step of determining a critical section based on the start event, a step of determining a priority of the request based on the identification information of the application, a step of setting and outputting the priority of a command generated based on the request, based on the priority of the request and the identification information of the application, and a step of scheduling the command based on the priority of the command.

A method of operating a storage system including a host device and a storage device according to one embodiment may include a step of generating a first start event including first information based on a first request of a first application in response to user input at a first time point, a step of generating a second start event including second information based on a second request of a second application different from the first application in response to user input at a second time point subsequent to the first time point, a step of detecting that the second start event indicates the start of a critical section based on the second information, and a step of increasing the priority of the second request above the priority of the first request.

### BRIEF DESCRIPTION OF THE DRAWINGS

FIG. 1 is a drawing for explaining a storage system according to one embodiment of the present disclosure.

FIG. 2 is a drawing for explaining a storage system according to one embodiment of the present disclosure.

FIG. 3 is a diagram for explaining information generated by an event generation module according to one embodiment of the present disclosure.

FIG. 4 is a diagram for explaining the operation of a storage system according to one embodiment of the present disclosure.

FIG. 5 is a diagram for explaining the operation of a storage system according to one embodiment of the present disclosure.

FIG. 6 is a diagram for explaining the operation of a storage system according to one embodiment of the present disclosure.

FIG. 7 is a diagram for explaining the operation of a storage system according to one embodiment of the present disclosure.

FIG. 8 is a diagram for explaining the operation of a storage system according to one embodiment of the present disclosure.

FIG. 9 is a diagram for explaining the operation of a storage system according to one embodiment of the present disclosure.

FIG. 10 is a flowchart for explaining an operation method of a storage system according to one embodiment of the present disclosure.

FIG. 11 is a drawing for explaining a storage system according to one embodiment of the present disclosure.

FIG. 12 is a diagram illustrating a mobile system according to one embodiment of the present disclosure.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as "a", "an", or "single" are used. Terms including an ordinal number, such as first and second, are used for describing various constituent elements, but the constituent elements are not limited by the terms. These terms are used only to discriminate one constituent element from other constituent elements.

Hereinafter, the present disclosure will be described in more detail through examples. These examples are just for illustrating the present disclosure, and the right protection scope of the present disclosure is not limited by the examples.

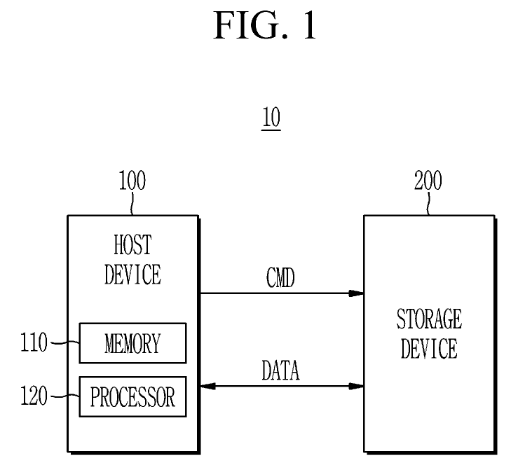

FIG. 1 is a drawing for explaining a storage system according to one embodiment of the present disclosure.

Referring to FIG. 1, the storage system 10 may include a host device 100 and a storage device 200. The host device 100 may include a memory 110 and a processor 120.

The host device 100 can store data DATA in the storage device 200 or read data DATA from the storage device 200. For example, the host device 100 can control the storage device 200 by transmitting a command CMD to the storage device 200.

In some embodiments, the processor 120 may be one of various types of processors, such as a central processing unit, a graphic processing unit, an application processor, and the like. In some embodiments, the processor 120 may execute a software module. Specifically, the processor 120 can execute software stored in the memory 110.

In some embodiments, the command CMD may include a read command, a write command, but the embodiments are not limited thereto and the command CMD may include more diverse types of commands.

Although not shown in FIG. 1, in some embodiments, the host device 100 may provide address information to the storage device 200. The address information may represent one or more bank addresses, row addresses, or column addresses. The storage device 200 can read data DATA or write data based on command CMD and address information. Meanwhile, the embodiment is not necessarily limited thereto, and the address information may represent more diverse types of addresses.

The storage device 200 may include a plurality of memory cells. The storage device 200 may include a V-NAND flash memory having a 2D structure or a 3D structure, but the embodiment is not necessarily limited thereto, and the storage device may include various types of memory cells such as PRAM and/or RRAM.

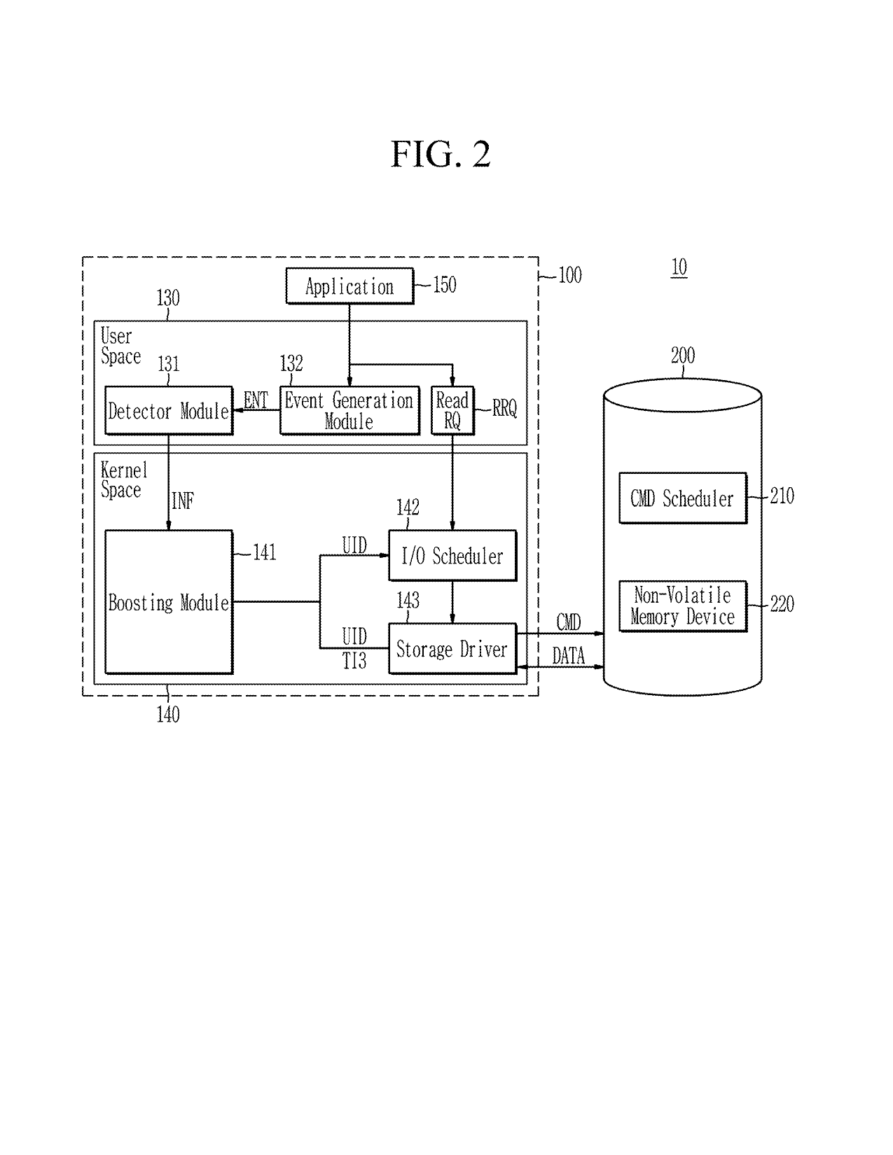

The storage device 200 can output stored data DATA in response to a read command from the host device 100. A read command provided from a host device 100 may be provided to a storage device 200 based on priority. Specific details are described below in FIG. 2.

FIG. 2 is a drawing for explaining a storage system according to one embodiment of the present disclosure.

Referring to FIG. 2, the storage system 10 may include a host device 100 and a storage device 200. The software architecture that may be stored in memory 110 within the host device 100 and executed by the processor 120 may include an application 150, a user space 130, and a kernel space 140. The user space 130 may include a detection module 131, an event generation module 132, and the kernel space 140 may include a boosting module 141, an input/output scheduler 142, and a storage driver 143. The storage device 200 may include a command scheduler 210 and a nonvolatile memory device 220.

The detection module 131 and the event generation module 132 can be implemented in the user space 130. The boosting module 141, input/output scheduler 142, and storage driver 143 can be implemented in the kernel space 140. The user space 130 and the kernel space 140 can be stored in memory 110 of FIG. 1 and, when executed by a processor 120 of FIG. 1, can have different execution space. Below, the software will be explained from the perspective of the operations or functions performed by each module when each module is implemented by executing the software by the processor 120.

The application 150 can be executed by the host device 100, specifically the processor 120. When a user input e.g., touch input is input to a running application 150, a read request RRQ can be generated to read the corresponding data. Additionally, when a user input e.g., touch input is input to a running application 150, the event generation module 132 can generate a start event ENT. A start event may include information INF containing information about the application 150 and information about the critical section.

Specifically, the event generation module 132 can predefine user inputs for which UX responsiveness is important, specifically, user inputs for which UX responsiveness is important for each application 150, and store information related thereto. When a specific user input is entered for a specific application 150 where UX responsiveness is predefined as important, the read request RRQ generated in response to it needs to be completed within a specific time period. In this specification, the specific time period may be referred to as a critical period.

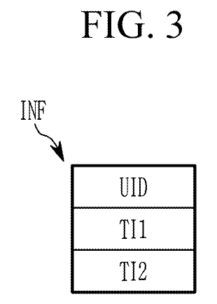

If the event generation module 132 determines that a user input for the application 150 corresponds to something for which UX responsiveness is important, it can generate information INF including information indicating the application 150 and information about a critical section so that a read request RRQ corresponding to the user input for the application 150 is executed within the critical section. Information INF may be included in a start event ENT and provided to the detection module 131. Regarding information INF, it is explained with reference to FIG. 3.

FIG. 3 is a diagram for explaining information generated by an event generation module according to one embodiment of the present disclosure.

Referring to FIG. 3, information INF generated by the event generation module 132 may include a unique ID UID, first time information TI1, and second time information TI2.

A unique identifier UID may be information that identifies an application. For example, in a first application and a second application that is different from the first application, the unique ID UID for the first application and the unique ID UID for the second application may be different from each other.

For example, if a user input to an application 150 corresponds to something important for UX responsiveness, the first time information TI1 may be information about the generation time of a start event ENT generated in response thereto. The first time information TI1 can indicate the start time of a critical section.

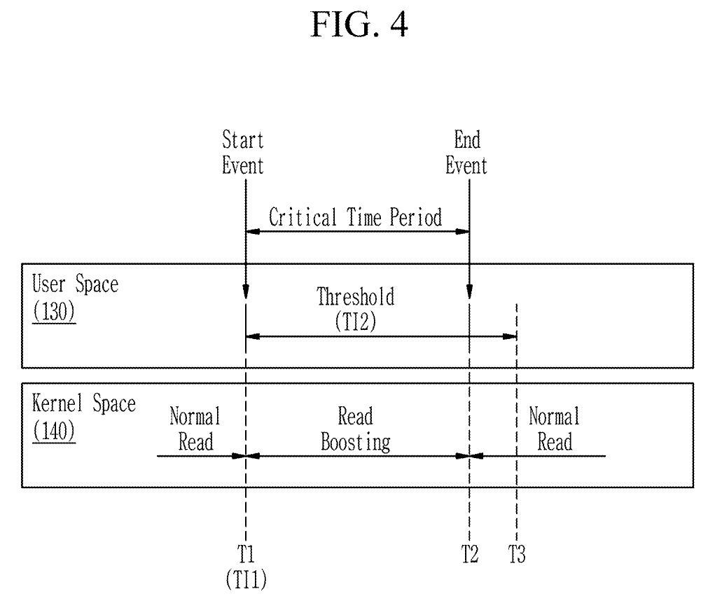

The second time information TI2 may be information indicating a specific point in time when a read request RRQ corresponding to a user input for an application must be completed by a specific point in time. For example, the second time information TI2 may include a threshold value representing a specific time interval. The first-time information TI1 and the second time information TI2 are described together with reference to FIG. 4.

FIG. 4 is a diagram for explaining the operation of a storage system according to one embodiment of the present disclosure.

Referring to FIG. 4, if a user input for a specific application 150 at a first time point T1 is determined to be important for UX responsiveness, the event generation module 132 may generate a start event ENT at the first time point T1. The event generation module 132 can generate a start event ENT including first time information TI1 and second time information TI2.

The first time information TI1 may include information indicating a first time point T1. The second time information TI2 may include information indicating a threshold time period within which a read request corresponding to a user input for an application 150 where UX responsiveness is important must be completed.

If a user input to an application 150 corresponds to something that is important for UX responsiveness, a read request generated in response thereto may need to be performed within a threshold time period determined based on second time information TI2 from a start time determined based on first time information TI1. That is, a critical section can be defined based on the first-time information TI1 and the second time information TI2, and a read request RRQ may be performed within the critical section.

Accordingly, a read request RRQ can be performed within a time period between a first time point T1 and a third time point T3 determined based on first time information TI1 and second time information TI2. For example, a read request RRQ can be completed at a second time point T2 before a third time point T3. When the read request RRQ is completed at the second time point T2, the event generation module 132 can generate a termination event. As a result, the critical section can correspond to the section from the first time point T1 when the start event is generated to the second time point T2 when the end event is generated.

That is, when the start of a critical section is detected by the first time information TI1 at the first time point T1, the critical section may correspond to a time period from the first time point T1 to the third time point T3 indicated by the second time information TI2, and a read request RRQ may have to be performed before the third time point T3.

The detection module 131 can receive a start event ENT containing information INF from the event generation module 132. The detection module 131 can detect that a critical section has started from a first time point T1 based on the first time information TI1. The detection module 131 can determine a critical section based on the first time information TI1 and the second time information TI2. The detection module 131 can provide information INF to the boosting module 141.

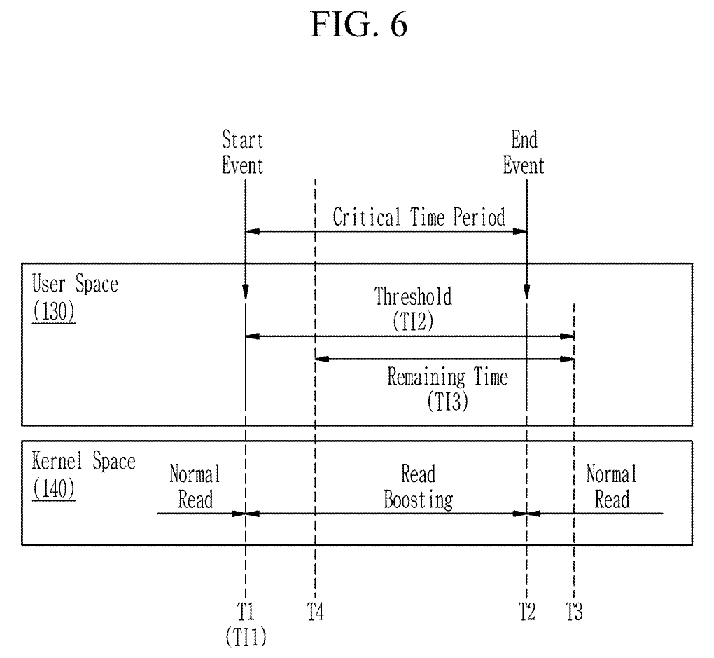

The boosting module 141 can increase the priority of a read request RRQ for which UX responsiveness is important based on the information INF provided from the detection module 131. The boosting module 141 can provide the unique ID UID of the application 150 among the information INF provided from the detection module 131 to the input/output scheduler 142 and the storage driver 143. The boosting module 141 can generate third time information TI3 based on the first time information TI1, second time information TI2, and current time among the information INF provided from the detection module 131. The boosting module 141 can provide third time information TI3 to the storage driver 143. The third time information TI3 is described later with reference to FIG. 6.

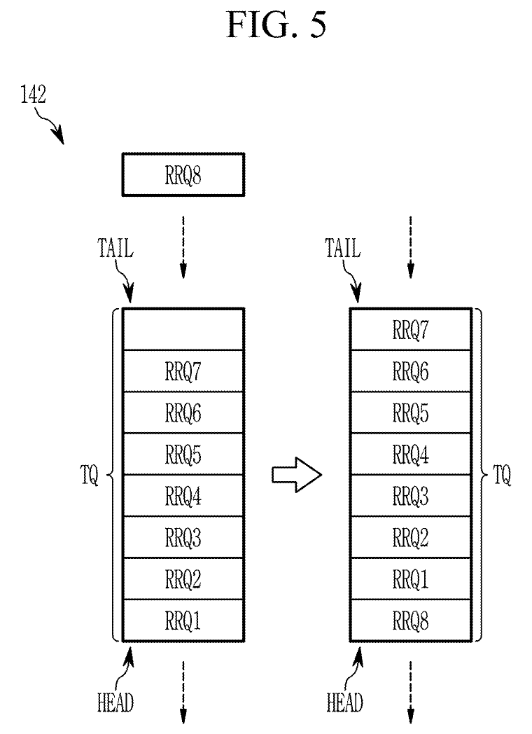

The input/output scheduler 142 can schedule the received read request RRQ. The input/output scheduler 142 can adjust the priority of a received read request RRQ based on a unique ID UID provided from the boosting module 141. Specific details are described later with reference to FIG. 5.

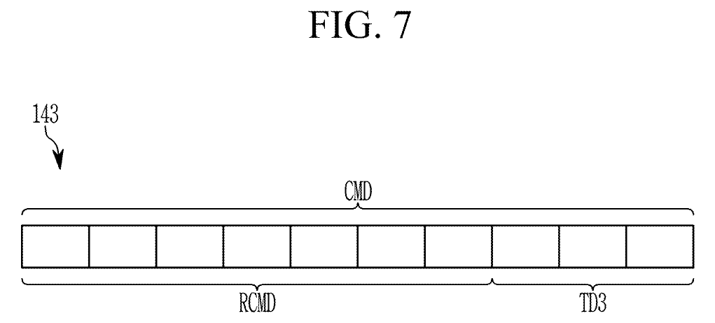

The storage driver 143 can receive a priority-adjusted read request RRQ from the input/output scheduler 142. The storage driver 143 can convert a received read request RRQ into a command CMD and provide it to the storage device 200. The storage driver 143 can set the priority of the command CMD based on the unique ID UID and third time information TI3 provided from the boosting module 141. Specific details are described below with reference to FIG. 7 and below.

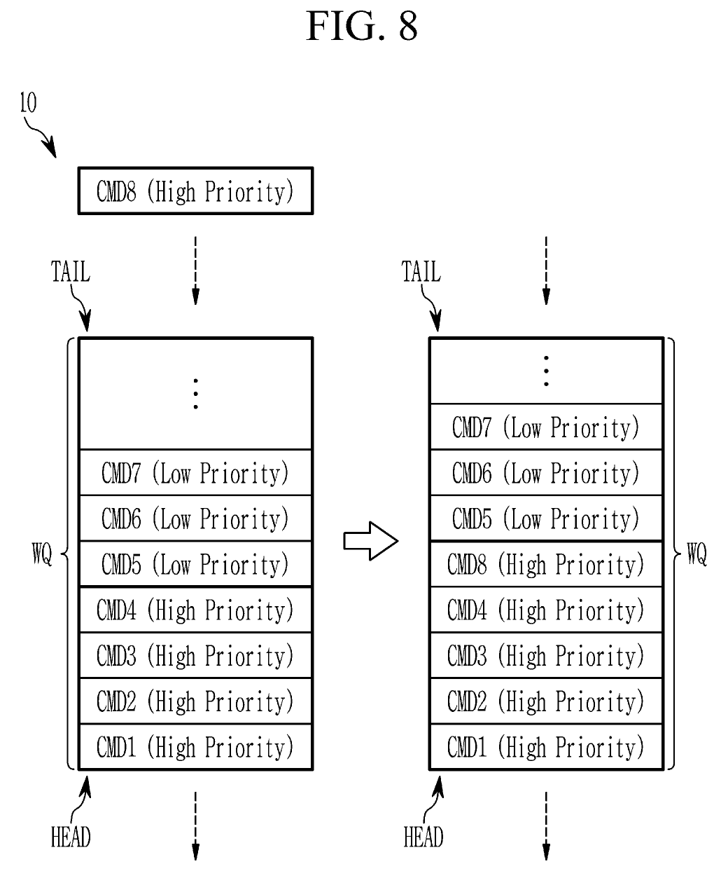

The command scheduler 210 can receive a command CMD generated from the storage driver 143. The command scheduler 210 can schedule a command CMD based on the priority of the command CMD set in the storage driver 143. Specific details are described later with reference to FIG. 8 and below.

A nonvolatile memory device 220 can read data corresponding to a read request RRQ. Data in the nonvolatile memory device 220 can be read according to a command provided based on priority by the command scheduler 210.

FIG. 5 is a diagram for explaining the operation of a storage system according to one embodiment of the present disclosure. Specifically, FIG. 5 is a diagram for explaining the operation of an input/output scheduler 142 according to one embodiment of the present disclosure.

Referring to FIG. 5, the input/output scheduler 142 may include a task queue TQ for processing multiple read requests RRQ1 to RRQ7. A task queue TQ can include a head HEAD and a tail TAIL, and can be implemented in a first-in-first-out FIFO manner by default. For example, among the first to seventh read requests RRQ1 to RRQ7, the first read request RRQ1 may be entered into the task queue TQ first and correspond to a pending request, and the seventh read request RRQ7 may be entered into the task queue TQ last and correspond to a pending request.

Meanwhile, in FIG. 5, the first to seventh read requests RRQ1 to RRQ7 can correspond to general read requests. For example, referring to FIG. 4, the first to seventh read requests RRQ1 to RRQ7 may be read requests generated before the first time point T1. That is, the first to seventh read requests RRQ1 to RRQ7 may be read requests that were not generated in the critical section.

On the other hand, the 8th read request RRQ8 can correspond to the read request to which read boosting will be applied. For example, referring to FIG. 4, the 8th read request RRQ8 may be a read request generated in a critical section between the first time point T1 and the third time point T3.

The input/output scheduler 142 can rearrange a plurality of read requests within the task queue TQ so that the 8th read request RRQ8 generated in the critical section has priority over the 1st to 7th read requests RRQ1 to RRQ7, which are general read requests. Specifically, the input/output scheduler 142 can determine that the 8th read request RRQ8 is a read request of an application corresponding to a critical section based on the unique ID provided from the boosting module 141 of FIG. 2. The input/output scheduler 142 can adjust the priorities of the plurality of read requests RRQ1 to RRQ8 so that the 8th read request RRQ8 is dequeued first from the task queue TQ before the 1st read request RRQ1.

As described above, the storage system according to one embodiment of the present disclosure can prevent ANR due to latency of a read request by adjusting the priority of a read request generated in a critical section, thereby providing an improved UX.

FIG. 6 is a diagram for explaining the operation of a storage system according to one embodiment of the present disclosure. Below, we will explain mainly the differences from FIG. 4.

Referring to FIG. 2 and FIG. 6, the boosting module 141 can generate first time information TI1, second time information TI2, and third time information TI3 based on the current time. The third time information TI3 may indicate the remaining time until the end of the threshold time interval based on the current time.

Specifically, when the current time corresponds to the fourth time point T4, the boosting module 141 can generate the third time information TI3 based on calculating the difference between the threshold time interval value indicated by the second time information TI2 and the time value elapsed from the first time point T1 to the fourth time point T4 indicated by the first time information TI1. The boosting module 141 can provide third time information TI3 to the storage driver 143.

FIG. 7 is a diagram for explaining the operation of a storage system according to one embodiment of the present disclosure. Specifically, FIG. 7 is a diagram for explaining a command CMD generated by a storage driver 143 according to one embodiment of the present disclosure.

Referring to FIGS. 2 and 7, the command CMD may include a read command RCMD and third time information TI. A read command RCMD can be generated in response to a read request RRQ. Data corresponding to a read request RRQ based on a read command RCMD can be read from a nonvolatile memory device 220.

As described with reference to FIGS. 2 and 6, the third time information TI3 can be provided from the boosting module 141 to the storage driver 143. The storage driver 143 can provide a command CMD including third time information TI3 and a read command RCMD to the storage device 200.

The storage driver 143 can set the priority of the generated command CMD based on the unique ID UID of the application 150 provided from the boosting module 141. Specifically, the storage driver 143 can identify the application 150 that generated the read request within the critical section based on a unique ID UID. The storage driver 143 can generate a command CMD corresponding to a read request RRQ generated by the application 150 and can assign a high priority to the command CMD.

Additionally, the storage driver 143 can also assign priorities to each of the high priority commands CMD based on the third time information TI3 provided from the boosting module 141. Specific details are explained with reference to FIG. 8 and below.

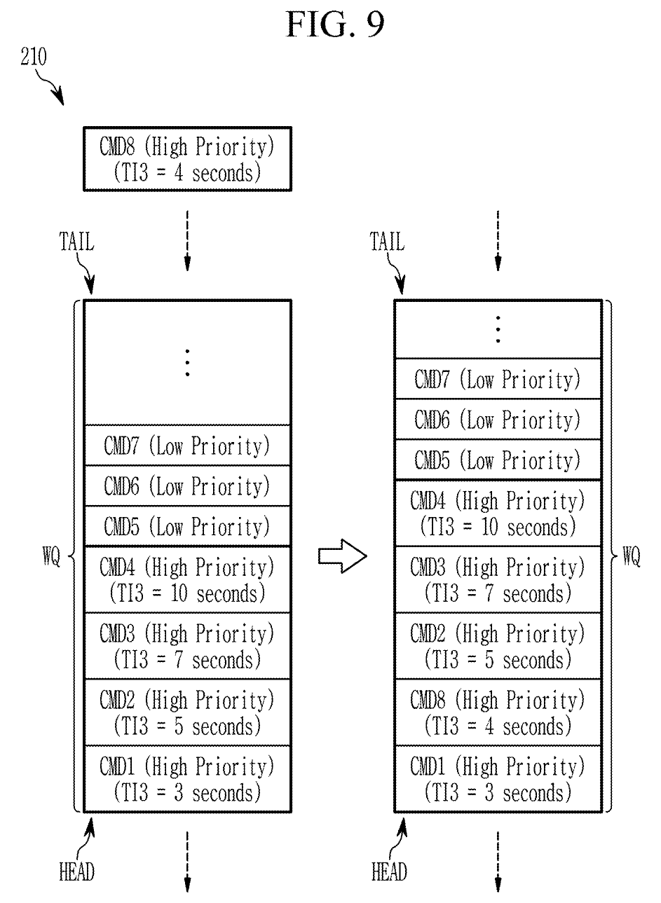

FIGS. 8 and 9 are diagrams for explaining the operation of a storage system according to one embodiment of the present disclosure. Specifically, FIGS. 8 and 9 are diagrams for explaining the operation of a command scheduler 210 according to one embodiment of the present disclosure.

Referring to FIG. 8, the command scheduler 210 may include a waiting queue WQ for scheduling the plurality of commands CMD1 to CMD7. A waiting queue WQ can contain a head HEAD and a tail TAIL, and can be implemented in a First-In-First-Out FIFO manner by default.

Meanwhile, the first to fourth commands CMD1 to CMD4 and the eighth command CMD8 may have high priorities, and the fifth to seventh commands CMD5 to CMD7 may have low priorities. For example, as described with reference to FIG. 7, the storage driver 143 of FIG. 2 can assign high priorities to the first to fourth commands CMD1 to CMD4 and the eighth command CMD8 and assign low priorities to the fifth to seventh commands CMD5 to CMD7 based on the provided unique ID UID of FIG. 2.

The command scheduler 210 can schedule the first to fourth commands CMD1 to CMD4 with high priorities to the head HEAD of the waiting queue WQ. Since the 8th command CMD8 that is subsequently inserted into the waiting queue WQ also has a high priority, the command scheduler 210 can schedule the 8th command CMD8 as the head HEAD with priority over the 5th to 7th commands CMD5 to CMD7 that have lower priorities.

Meanwhile, the command scheduler 210 can schedule the plurality of commands with the same high priority based on priority.

Referring to FIG. 9, similarly to the embodiment of FIG. 8, the first to fourth commands CMD1 to CMD4 and the eighth command CMD8 may have high priorities, and the fifth to seventh commands CMD5 to CMD7 may have low priorities.

Meanwhile, each of the first to fourth commands CMD1 to CMD4 and the eighth command CMD8 may include third time information TI3. For example, as described with reference to FIG. 7, the storage driver 143 of FIG. 2 may include third time information TI3, which indicates the remaining time until execution completion, in each command CMD and provide it to the command scheduler 210.

The command scheduler 210 can additionally adjust the priorities of the first to fourth commands CMD1 to CMD4 and the eighth command CMD8 having the same high priority based on the third time information TI3. Specifically, a large weight can be assigned to a command with a small remaining time indicated by the third time information TI3, and the command with a large weight can be scheduled as the head of the waiting queue WQ so that the command is processed with priority.

In the example of FIG. 9, the third time information TI3 of the 8th command CMD8 subsequently inserted into the waiting queue WQ may indicate that it is 4 seconds. The third time information TI3 of the second command CMD2 and the third command CMD3 pending in the waiting queue WQ can be indicated as 5 seconds and 7 seconds, respectively. That is, the second command CMD2, the third command CMD3, and the eighth command CMD8 are commands corresponding to requests generated in the same critical section, and even though they have the same high priority, since the remaining time identified by the third time information TI3 included in the eighth command CMD is smaller, the command scheduler 210 can schedule the eighth command CMD8 to the head HEAD of the waiting queue WQ with priority over the second command CMD2 and the third command CMD3.

As described above, the storage system according to one embodiment of the present disclosure can prevent ANR due to latency of a read request by adjusting the priority of each read request based on the remaining time until execution completion, even for a plurality of read requests generated in a critical section, thereby providing an improved UX.

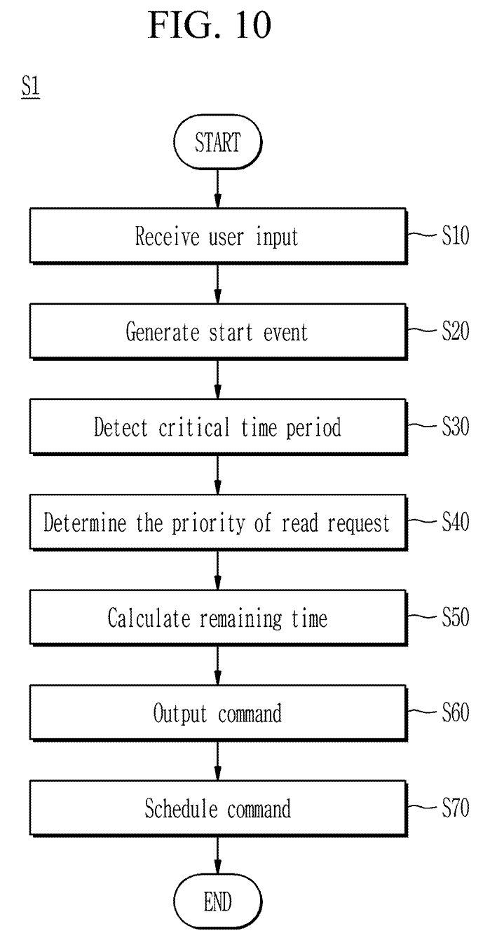

FIG. 10 is a flowchart for explaining an operation method of a storage system according to one embodiment of the present disclosure.

Referring to FIG. 10, the operating method S1 of the storage system may include a step of receiving user input S10.

For example, the storage system 10 in FIG. 1 can receive user input e.g., touch input through a user interface.

The method of operating the storage system S1 may include a step of generating a start event S20.

For example, when a user input is received for a running application 150 in FIG. 2, the event generation module 132 in FIG. 2 can generate a start event ENT in FIG. 2 in response. In some embodiments, the event generation module 132 may generate information to identify the running application 150 i.e., a unique ID UID of FIG. 3. When a read request corresponding to a user input for the application 150 must be completed during a critical section, the event generation module 132 can generate first time information TI1 of FIG. 3 indicating a start time of the critical section and second time information TI2 of FIG. 3 indicating a critical time period of the critical section. The event generation module 132 can generate information INF including a unique ID UID, first time information TI1, and second time information TI2. The event generation module 132 can provide a start event ENT containing information INF to the detection module 131 of FIG. 2.

The operating method S1 of the storage system may include a step of detecting a critical time period S30.

For example, the detection module 131 can detect a critical section based on information INF of a start event ENT provided from the event generation module 132. Specifically, the detection module 131 can detect a critical section by detecting the start time of the critical section through the first time information TI1 and detecting the threshold time value of the critical section through the second time information TI2.

The method of operating the storage system S1 may include a step of determining a priority of a read request S40.

For example, the detection module 131 can provide information INF to the boosting module 141 of FIG. 2, and the boosting module 141 can provide a unique ID UID among the provided information INF to the input/output scheduler 142 of FIG. 2. The input/output scheduler 142 can adjust the priority of a read request generated in a critical section among read requests based on the received unique ID UID. Specifically, the input/output scheduler 142 can schedule a read request generated in a critical section among the plurality of read requests pending in a task queue TQ of FIG. 5 to the head of the task queue TQ.

The method of operating the storage system S1 may include a step of calculating a remaining time S50.

For example, the boosting module 141 can generate third time information TI3 based on the first time information TI1, the second time information TI2, and the current time among the provided information INF. The third time information TI3 may indicate the remaining time until the end of the threshold time interval based on the current time. The boosting module 141 can provide the generated third time information TI3 to the storage driver 143 in FIG. 2.

The method of operating the storage system S1 may include a step of outputting a command S60.

For example, the storage driver 143 can generate read commands RCMD of FIG. 7 corresponding to the plurality of read requests received from the input/output scheduler 142. The storage driver 143 can receive third time information TI3 corresponding to each of a plurality of read requests from the boosting module 141. The storage driver 143 can generate and output a command CMD including a read command RCMD and third time information TI3. The storage driver 143 can set the priority of a command CMD and output it based on the unique ID UID received from the boosting module 141.

The method of operating the storage system S1 may include a step of scheduling a command S70.

For example, the command scheduler 210 in FIG. 2 can schedule commands based on the priority of the commands received from the storage driver 143. The command scheduler 210 can schedule a command with a high priority to the head of the waiting queue WQ in FIG. 8. The command scheduler 210 can schedule a command with a short remaining time, identified based on third time information TI3, among the plurality of commands having the same high priority, to the head of the waiting queue WQ.

The operating method of a storage system according to one embodiment of the present disclosure can prevent ANR due to latency of a read request by increasing the priority of a plurality of read requests generated in a critical section and adjusting the priority of each of the plurality of read requests based on the remaining time until execution completion, thereby providing an improved UX.

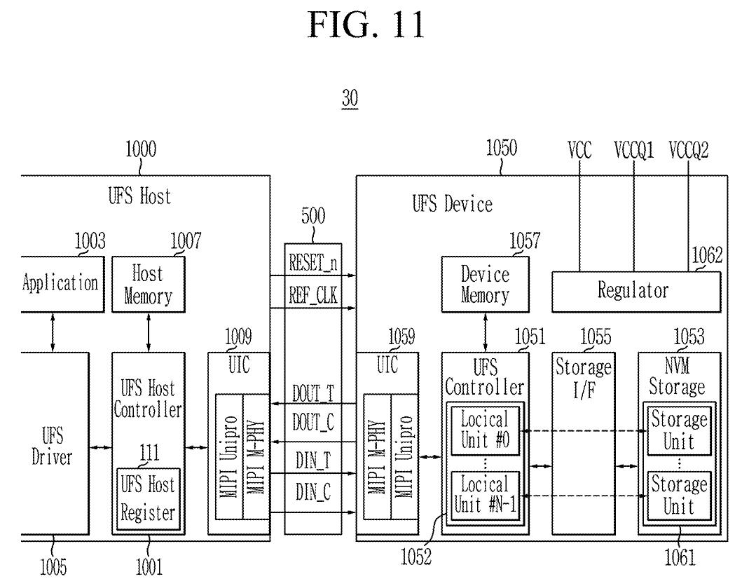

FIG. 11 is a drawing for explaining a storage system according to one embodiment of the present disclosure.

Specifically, FIG. 11 is a drawing illustrating a case where the storage system 10 in FIG. 1 described with reference to FIGS. 1 to 10 is a system that follows the Universal Flash Storage standard announced by JEDEC Joint Electron Device Engineering Council.

Referring to FIG. 11, the UFS system 30 may include a UFS host device 1000, a UFS device 1050, and a UFS interface 500.

The UFS host device 1000 and the UFS device 1050 can be interconnected via the UFS interface 500. In some embodiments, the UFS host device 1000 may be implemented as part of an application processor.

A UFS host device 1000 may include a UFS host controller 1001, an application 1003, a UFS driver 1005, host memory 1007, and a UFS interconnect layer 1009.

A UFS device 1050 may include a UFS device controller 1051, non-volatile storage 1053, a storage interface 1055, device memory 1057, a UIC layer 1059, and a regulator 1062.

Non-volatile storage 1053 may include the plurality of storage units 1061. The plurality of storage units 1061 may include V-NAND flash memory of a 2D structure or a 3D structure, but the embodiment is not limited thereto, and each of the plurality of storage units 1061 may include another type of non-volatile memory, such as PRAM and/or RRAM.

The UFS device controller 1051 and non-volatile storage 1053 may be connected to each other through a storage interface 1055. The storage interface 1055 may be implemented to comply with standard protocols such as Toggle or ONFI.

The application 1003 may be a program that communicates with the UFS device 1050 to utilize the functions of the UFS device 1050. An application 1003 can send an input-output request IOR to a UFS driver 1005 for input/output to a UFS device 1050. Input/output requests may include, but are not limited to, data read requests, write requests, and/or erase requests.

Meanwhile, although not shown in FIG. 11, the UFS host device 1000 may include a user space e.g., 130 of FIG. 2 and a kernel space e.g., 140 of FIG. 2. A start event can be generated in response to a user input to an application 1003 in the user space of a UFS host device 1000, and a critical section of a corresponding read request can be determined. The priority of an input/output request from an application 1003 can be determined in the kernel space of a UFS host device 1000, and the priority of a UFS command generated by a UFS driver 1005 can be set.

The UFS driver 1005 can manage the UFS host controller 1001 through the UFS-HCI host controller interface. The UFS driver 1005 can convert input/output requests generated by the application 1003 into UFS commands defined by the UFS standard and transmit the converted UFS commands to the UFS host controller 1001. A single I/O request can be translated into the plurality of UFS commands. UFS commands can be commands defined primarily by the Small Computer System Interface SCSI standard, but can also be commands specific to the UFS standard.

In some embodiments, the UFS command converted by the UFS driver 1005 may include third time information TI3 as described with reference to FIG. 8. For example, when the UFS driver 1005 receives a read request from an application 1003, the UFS driver 1005 can convert the read request and the third time information TI3 into a UFS command defined by the UFS standard and transmit it to the UFS host controller 1001.

The UFS host controller 1001 can transmit a UFS command converted by the UFS driver 1005 to the UIC layer 1059 of the UFS device 1050 through the UIC layer 1009 and the UFS interface 500. In this case, the UFS host register 111 of the UFS host controller 1001 can function as a command queue CQ. The UIC layer 1009 on the UFS host device 1000 side may include MIPI M-PHY and MIPI UniPro, and the UIC layer 1059 on the UFS device 1050 side may also include MIPI M-PHY and MIPI UniPro.

The UFS interface 500 may include a line transmitting a reference clock REF_CLK, a line transmitting a hardware reset signal RESET_n for the UFS device 1050, a pair of lines transmitting a differential input signal pair DIN_T and DIN_C, and a pair of lines transmitting a differential output signal pair DOUT_T and DOUT_C.

The UFS device 1050 can generate clocks of various frequencies from a reference clock provided from the UFS host device 1000 using a phase-locked loop PLL, etc. Additionally, the UFS host device 1000 can also set a data rate value between the UFS host device 1000 and the UFS device 1050 through the frequency value of the reference clock. That is, the value of the data rate can be determined depending on the frequency value of the reference clock.

The UFS device controller 1051 may include the plurality of logical units 1052. Also, although not shown in FIG. 11, the UFS device controller 1051 may include a command scheduler 210 of FIG. 2. Based on the operation of the command scheduler 210 as described with reference to FIGS. 8 and 9, the UFS device controller 1051 can schedule a plurality of UFS commands provided from the UFS host device 1000 based on priorities. For example, the UFS device controller 1051 can schedule the plurality of UFS commands based on third time information TI3 included in each UFS command.

The UFS interface 500 can support the plurality of lanes, and each lane can be implemented as a differential pair. For example, a UFS interface 500 may include one or more receive lanes and one or more transmit lanes. In FIG. 11, a pair of lines transmitting a differential input signal pair DIN_T and DIN_C can constitute a receiving lane, and a pair of lines transmitting a differential output signal pair DOUT_T and DOUT_C can constitute a transmitting lane. Although FIG. 11 illustrates one transmission lane and one reception lane, the number of transmission lanes and reception lanes may be modified and implemented.

The receiving lane and the transmitting lane can transmit data in a serial communication manner, and full-duplex communication between the UFS host device 1000 and the UFS device 1050 is possible due to the structure in which the receiving lane and the transmitting lane are separated. That is, the UFS device 1050 can transmit data to the UFS host device 1000 through the transmission lane even while receiving data from the UFS host device 1000 through the reception lane. Additionally, control data such as commands from a UFS host device 1000 to a UFS device 1050, and user data that the UFS host device 1000 wants to store in or read from a non-volatile storage 1053 of the UFS device 1050 can be transmitted through the same lane. Accordingly, there is no need to provide a separate lane for data transmission other than a pair of receiving lanes and a pair of transmitting lanes between the UFS host device 1000 and the UFS device 1050.

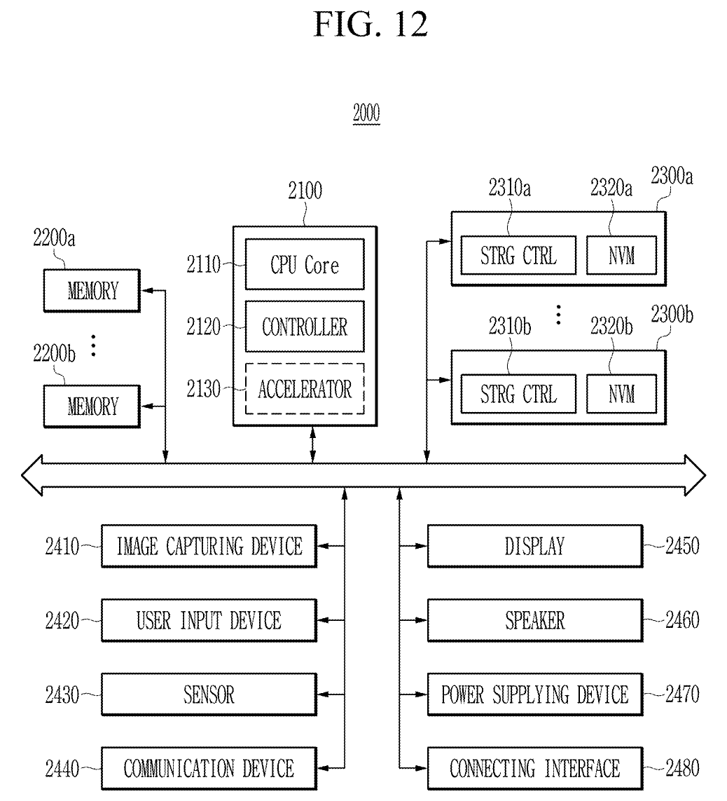

FIG. 12 is a diagram illustrating a mobile system according to one embodiment of the present disclosure.

The mobile system 2000 of FIG. 12 may be a mobile system such as a mobile phone, a smart phone, a tablet personal computer, a wearable device, a healthcare device, or an Internet of Things IoT device. However, the mobile system 2000 of FIG. 12 is not limited thereto, and may be a personal computer, a laptop computer, a server, a media player, or an automotive device such as a navigation device.

Referring to FIG. 12, the mobile system 2000 may include a main processor 2100, a memory 2200a, 2200b, and a storage device 2300a, 2300b. Additionally, the mobile system 2000 may further include one or more of an image capturing device 2410, a user input device 2420, a sensor 2430, a communication device 2440, a display 2450, a speaker 2460, a power supplying device 2470, and a connecting interface 2480.

The main processor 2100 may be implemented as a host device 100 described with reference to FIG. 1 or a UFS host device 1000 described with reference to FIG. 11. The storage device 2300a, 2300b may be implemented as a storage device 200 described with reference to FIGS. 1 to 10, or a UFS device 1050 described with reference to FIG. 11.

The main processor 2100 can control the overall operation of the mobile system 2000. In some embodiments, the main processor 2100 may be implemented as a general-purpose processor, a dedicated processor, or an application processor.

The main processor 2100 may include one or more CPU cores 2110 and may further include a controller 2120 for controlling memory 2200a, 2200b and/or storage devices 2300a, 2300b. In some embodiments, the main processor 2100 may further include an accelerator 2130, which is a dedicated circuit for high-speed data operations such as AI data operations. The accelerator 2130 may include a Graphics Processing Unit, an Neural Processing Unit, and/or a Data Processing Unit, and may be implemented as a separate chip that is physically independent from other components of the main processor 2100.

The memory 2200a, 2200b may be used as a main memory device of the mobile system 2000 and may include volatile memory such as SRAM and/or DRAM, but may also include non-volatile memory such as flash memory, PRAM and/or RRAM. The memory 2200a, 2200b may also be implemented within the same package as the main processor 2100.

In some embodiments, the software architecture that may be stored in memory 2200a, 2200b and executed by the main processor 2100 may include a user space e.g., 130 of FIG. 2, a kernel space e.g., 140 of FIG. 2, and an application e.g., 150 of FIG. 2. In user space, a start event can be generated in response to user input to the application, and the critical section of the corresponding read request can be determined. In kernel space, the priorities of input/output requests from applications can be determined, and the priorities of commands corresponding to the input/output requests can be set.

The storage device 2300a, 2300b can function as a non-volatile storage device that stores data regardless of whether power is supplied, and can have a relatively large storage capacity compared to the memory 2200a, 2200b. A storage device 2300a, 2300b may include a storage controller 2310a, 2310b STRG CTRL and a nonvolatile memory NVM 2320a, 2320b that stores data under the control of the storage controller 2310a, 2310b.

In some embodiments, the storage controller 2310a, 2310b may include a command scheduler e.g., 210 of FIG. 2. Based on the operation of the command scheduler as described with reference to FIGS. 8 and 9, the storage controller 2310a, 2310b can schedule the plurality of commands provided from the main processor 2100 based on priorities.

In some embodiments, the software architecture that may be stored in memory 2200a, 2200b and executed by the main processor 2100 may include a user space e.g., 130 of FIG. 2, a kernel space e.g., 140 of FIG. 2, and an application e.g., 150 of FIG. 2. In user space, a start event can be generated in response to user input to the application, and the critical section of the corresponding read request can be determined. In kernel space, the priorities of input/output requests from applications can be determined, and the priorities of commands corresponding to the input/output requests can be set.

The nonvolatile memory 2320a, 2320b may include flash memory of a 2D 2-dimensional structure or a 3D 3-dimensional V-NAND Vertical NAND structure, but may also include other types of nonvolatile memory such as PRAM and/or RRAM.

The storage device 2300a, 2300b may be included in the mobile system 2000 physically separated from the main processor 2100, or may be implemented within the same package as the main processor 2100. In addition, the storage device 2300a, 2300b may have a form such as an SSD Solid State Device or a memory card, and may be detachably connected to other components of the mobile system 2000 through an interface such as a connection interface 2480 to be described later. Such storage devices 2300a, 2300b may be devices to which standard specifications such as UFS Universal Flash Storage, eMMC embedded Multi-Media Card or NVMe non-volatile memory express are applied, but the embodiments are not necessarily limited thereto.

The recording device 2410 can record still images or moving images and may be a camera, a camcorder, and/or a webcam.

The user input device 2420 can receive various types of data input from a user of the mobile system 2000, and may be a touch pad, a keypad, a keyboard, a mouse, and/or a microphone.

The sensor 2430 can detect various types of physical quantities that can be obtained from outside the mobile system 2000 and convert the detected physical quantities into electrical signals. Such sensors 2430 may be temperature sensors, pressure sensors, light sensors, position sensors, acceleration sensors, biosensors, and/or gyroscope sensors.

The communication device 2440 can transmit and receive signals between other devices outside the mobile system 2000 according to various communication protocols. Such a communication device 2440 may be implemented including an antenna, a transceiver, and/or a modem.

The display 2450 and speaker 2460 can function as output devices that output visual information and auditory information, respectively, to a user of the mobile system 2000.

The power supply unit 2470 can appropriately convert power supplied from a battery not shown built into the mobile system 2000 and/or an external power source and supply it to each component of the mobile system 2000.

The connection interface 2480 can provide a connection between the mobile system 2000 and an external device that is connected to the mobile system 2000 and can exchange data with the mobile system 2000. The connection interface 2480 can be implemented in various interface methods such as Advanced Technology Attachment, Serial ATA, e-SATA, Small Computer Small Interface, Serial Attached SCSI, Peripheral Component Interconnection, PCI express, NVMe, IEEE 1394, USB universal serial bus, SD secure digital card, MMC multi-media card, eMMC, UFS, embedded Universal Flash Storage, CF compact flash card interface, etc.

Although the embodiments of the present invention have been described in detail above, the scope of the present invention is not limited thereto, and various modifications and improvements made by those skilled in the art using the basic concept of the present invention defined in the following claims also fall within the scope of the present invention.

What is claimed is:

1. A storage system comprising:
a host device configured to:
generate a start event including identification information of an application, information about a start time, and information about a critical time period based on a request of the application,
determine a critical section based on the start event,
determine a priority of the request based on the identification information of the application,
generate a command based on the request, and
set and output a priority of the command based on the priority of the request and the identification information of the application; and
a storage device configured to schedule the command to a waiting queue based on the priority of the command received from the host device.

2. The storage system of claim 1, wherein:
the host device is configured to increase the priority of the request within the critical section.

3. The storage system of claim 1, wherein:
the storage device is configured to schedule a command with a higher priority to a head of the waiting queue.

4. The storage system of claim 1, wherein:
the host device is further configured to calculate a remaining time based on a current time, information about the start time, and information about the critical time period, and output information about the remaining time.

5. The storage system of claim 4, wherein:
the storage device is further configured to receive information about the remaining time, and schedule the command to the waiting queue based on the priority of the command and the information about the remaining time.

6. The storage system of claim 5, wherein:
the storage device is configured to compare the remaining time of each of a first command and a second command having the same priority, and increase the priority of a command, among the first command and the second command, having a smaller remaining time.

7. The storage system of claim 1, wherein:
the storage device is a Universal Flash Storage device.

8. The storage system of claim 1, wherein:
the host device comprises a processor and memory,
the host device is configured to:
generate the start event and determine the critical section in user space stored in the memory and executed by the processor, and
determine the priority of the request and output the command by setting the priority of the command in kernel space stored in the memory and executed by the processor.

9. A method of operating a storage system including a host device and a storage device, comprising:
receiving user input for an application;
generating a start event including identification information of the application, information about a start time, and information about a critical time period based on a request of the application;
determining a critical section based on the start event;
determining a priority of the request based on the identification information of the application;
setting and outputting the priority of a command generated based on the request, based on the priority of the request and the identification information of the application; and
scheduling the command based on the priority of the command.

10. The method of operating a storage system of claim 9, wherein:
determining the priority of the request includes increasing the priority of the request within the critical section.

11. The method of operating a storage system of claim 9, wherein:
scheduling the command includes scheduling a command having a higher priority among the command to a head of a waiting queue.

12. The method of operating a storage system of claim 9, further comprising:
calculating a remaining time based on a current time, information about the start time, and information about the critical time period; and
outputting information about the remaining time.

13. The method of operating a storage system of claim 12, wherein:
scheduling the command includes scheduling the command into a waiting queue based on information about the remaining time.

14. The method of operating a storage system of claim 13, wherein:
scheduling the command includes:
comparing the remaining time of each of a first command and a second command having the same priority; and
increasing the priority of a command with a short remaining time among the first command and the second command.

15. The method of operating a storage system of claim 9, wherein:
the storage device is a Universal Flash Storage device.

16. The method of operating a storage system of claim 9, wherein:
the host device includes a processor and memory,
generating the start event and the step of determining the critical section are performed in user space stored in the memory and executed by the processor, and
determining the priority of the request and setting the priority of the command and outputting the command are performed in kernel space stored in the memory and executed by the processor.

17. A method of operating a storage system including a host device and a storage device, comprising:
generating a first start event including first information based on a first request of a first application in response to user input at a first time point;
generating a second start event including second information based on a second request of a second application different from the first application in response to user input at a second time point subsequent to the first time point;
detecting that the second start event indicates the start of a critical section based on the second information; and
increasing a priority of the second request above a priority of the first request.

18. The method of operating a storage system of claim 17, wherein:
the second information includes identification information of the second application, first time information indicating the time at which the second start event is generated, and second time information indicating a critical time period within which the second request must be completed.

19. The method of operating a storage system of claim 17, further comprising:
generating a third start event including third information based on a third request of the second application at a third time point subsequent to the second time point within the critical section;
generating a second command based on the second request;
generating a third command based on the third request; and
scheduling the second command and the third command.

20. The method of operating a storage system of claim 19, further comprising:
outputting information about remaining time of the second request based on the second information; and
outputting information about remaining time of the third request based on the third information; and
wherein scheduling the second command and the third command includes increasing a priority of the third command above a priority of the second command when the remaining time of the third request is less than the remaining time of the second request.
